(19) United States
(12) Patent Application Publication
(10) Pub. No.: US 2024/0401674 A1
(43) Pub. Date: Dec. 5, 2024

(54) VERTICALLY-MOUNTED MICRO FRICTION DRAG CHAIN MECHANISM

(71) Applicant: National Institute of Metrology, China, Beijing (CN)

(72) Inventors: Jianshuang Li, Beijing (CN); Lianfu Li, Beijing (CN); Dongjing Miao, Beijing (CN); Jiaxiang Zhu, Beijing (CN); Deli Wang, Beijing (CN)

(21) Appl. No.: 18/661,630

(22) Filed: May 12, 2024

(30) Foreign Application Priority Data
Jun. 1, 2023 (CN) 2023106379218

(51) Int. Cl. F16H 7/18; F16H 7/06

(52) U.S. Cl. CPC F16H 7/18; F16H 7/06

(57) ABSTRACT

A vertically-mounted micro friction drag chain mechanism is provided and includes a supporting roller, an auxiliary roller and a vertically-mounted drag chain. An end of the drag chain is disposed on a supporting roller, another end of the drag chain extends from the supporting roller to the auxiliary roller, turns at the auxiliary roller and extends towards the supporting roller. The supporting roller is configured to drive the drag chain on the auxiliary roller to move. The drag chain mechanism discards a traditional tracked design, the auxiliary roller is added to shorten the length of the drag chain. The drag chain does not generate mutual friction during movement, so the frictional force experienced by the guide air floating platform during the entire operation process from the starting position to the end remains almost unchanged, greatly improving the stability of the air floating platform's control positioning.

### TECHNICAL FIELD

The disclosure relates to the technical field of drag chains (also referred to as cable chains or cable carriers), and particularly to a vertically-mounted micro friction drag chain mechanism.

### BACKGROUND

A precision long guide rail measurement device mainly includes guide rails, a motion platform, a length measurement system, and a control system. The precision positioning of the precision long guide rail measurement device is mainly influenced by the precision of the guide rails, the control system, and the length measurement system. However, when the machining and installation accuracy of the guide rails (e.g., long guide rails), and the accuracy of the control system and the length measurement system are ensured, in order to achieve the positioning accuracy in control at a micrometer level, a drag chain mechanism that follows the motion platform becomes a biggest influencing factor.

Uncertain external forces caused by the state of the drag chain within a full-length range of the long guide rails, friction caused by automatic stacking of the drag chain, and friction between the drag chain and the contact surface are the main reason that affects the positioning accuracy of the motion platform on the long guide rail measurement device. In order to reduce friction contact surface of the relative movement of the drag chain and reduce the impact of friction caused by the external forces of the motion platform, the length of the drag chain can be shortened as much as possible while meeting the requirements of the platform's motion range.

At present, the drag chain used for the precision long guide rail measurement devices on the market is generally fixed in the middle of the travel and extend to two sides of the middle of the travel. When the motion platform is in the middle position of the guide rail, the drag chain is stacked up and down in a drag chain groove at a left side of the precision long guide rail measurement device, and a roller is disposed above the drag chain groove on the right side of the precision long guide rail measurement device. When the motion platform moves from the middle position, the drag chain moves through the roller, making the stacking area of the drag chain smaller and the frictional external force acting on the motion platform smaller and smaller. However, the motion of the motion platform within the full range of the long guide rail is affected by the gravity of the drag chain itself. The frictional force between the drag chains increases with the increase of the stacking area of the drag chains, and the frictional external force of the drag chain constantly changes. For ultra-long guide rails larger than 50 meters (m), the frictional external force of the drag chain in certain areas of the ultra-long guide rail will be much greater than the static driving force of the motion platform, causing great uncertainty in the driving positioning of the motion platform at any position on the ultra-long guide rail, making it difficult to achieve the requirements of the precise positioning. In addition, due to the contact motion between the drag chain and the drag chain groove, the gradual increasing of the stacked friction force between the drag chain will lead to an increase in the noise generated, and it will also damage the lifespan of the drag chain itself.

### SUMMARY

In response to the phenomenon that the uneven friction caused by the increasing running distance of the drag chain during the precision detection process on a guide rail (e.g., long guide rail) in related art affects the operability and stability of the trolley on the guide rail, thereby affecting the detection accuracy, a main purpose of the disclosure is to provide a vertically-mounted micro friction drag chain mechanism, so that the friction force brought by the drag chain during the working process is not affected by the running distance, but is always kept uniform, and the drag chain can be adapted to any guide rail, the main purpose of which is to improve the stability of the trolley when it is running, and ultimately, to improve the detection accuracy.

In order to achieve above purpose, the technical solutions are as follows.

A vertically-mounted micro friction drag chain mechanism is provided and includes a supporting roller, an auxiliary roller and a vertically-mounted drag chain. An end of the drag chain is disposed on the supporting roller, another end of the drag chain extends from the supporting roller to the auxiliary roller, turns at the auxiliary roller and extends towards the supporting roller. The supporting roller is configured to drive the drag chain on the auxiliary roller to move.

In an embodiment, the supporting roller is used to replace a drag chain groove, the supporting roller is configured to support the vertically-mounted drag chain and place a motor drive line required for driving a trolley or a drive line matched with a guide rail in the vertically-mounted drag chain.

In an embodiment, the auxiliary roller includes two roller covers, a bearing and a support shaft; the bearing is disposed between the two roller covers, the support shaft is disposed on a side of one of the two roller covers facing away from the bearing. An end of the support shaft is connected to the side of the one of the two roller covers facing away from the bearing, and another end of the support shaft is configured to be connected to a guide rail.

In an embodiment, a turning radius of the drag chain at the auxiliary roller is less than a distance between the two roller covers.

The beneficial effects of the disclosure are as follows.

Compared with the related art, the drag chain mechanism of the disclosure discards the traditional tracked design and space on the side of the guide rail to place the drag chain vertically. In addition, the auxiliary roller is added on the original basis of the guide rail, and a space slightly larger than the minimum turning radius is disposed at the turning point of the drag chain. Compared to the installation method without rollers, adding the auxiliary roller can shorten length of the drag chain groove and shorten the length of the drag chain (usually ½ of the length of the guide rail). Due to the presence of the auxiliary roller, the two parts of the drag chain on the guide rail will not be affected by their own gravity during operation of the trolley and friction between the two parts of the drag chain themselves is not caused. The design at the turning point also better ensures the smooth operation of the drag chain. The friction force experienced by the guide rail from operation to end is almost unchanged, so the guide rail will not be affected by running distance and will not affect operational stability, which greatly ensures the detection accuracy.

### BRIEF DESCRIPTION OF DRAWINGS

FIG. 1 illustrates an overall structural schematic diagram of a vertically-mounted micro friction drag chain mechanism of the disclosure.

FIG. 2 illustrates a structural schematic diagram of an auxiliary roller of the vertically-mounted micro friction drag chain mechanism in the disclosure.

FIG. 3 illustrates a structural schematic diagram of a roller cover of the vertically-mounted micro friction drag chain mechanism in the disclosure.

FIG. 4 illustrates a structural schematic diagram of a bearing of the vertically-mounted micro friction drag chain mechanism in the disclosure.

FIG. 5 illustrates a structural schematic diagram of a horizontally-mounted drag chain mechanism of the disclosure.

FIG. 6 illustrates a schematic diagram of tension curves for different installation methods of drag chains.

Description of reference numerals: 1. supporting roller; 2. auxiliary roller; 3. roller cover; 4. drag chain groove; 5. bearing; 6. support shaft; 7. drag chain.

### DETAILED DESCRIPTION OF EMBODIMENTS

The specific embodiments of the disclosure are described below for the convenience of those skilled in the art to understand the disclosure. However, it should be clear that the disclosure is not limited to the scope of specific embodiments. For those skilled in the art, as long as various changes are within the spirit and scope of the disclosure as defined and determined by the attached claims, these changes are obvious, and all inventions and creations utilizing the concept of the disclosure are under protection.

### Embodiment 1

As shown in FIG. 1, a vertically-mounted micro friction drag chain mechanism is provided and includes a supporting roller 1, an auxiliary roller 2 and a vertically-mounted drag chain 7. An end of the drag chain 7 is disposed on the supporting roller 1, another end of the drag chain 7 extends from the supporting roller 1 to the auxiliary roller 2, turns at the auxiliary roller 2 and extends towards the supporting roller 1. The supporting roller 1 is configured to drive the drag chain 7 on the auxiliary roller 2 to move. A drag chain groove 4 is defined below the supporting roller 1. When the drag chain moves with a guide rail, there is no drag chain stacking phenomenon between upper and lower parts of the drag chain (i.e., the drag chain divides into the upper and lower parts after making the turn at the auxiliary roller 2), and there is no contact movement between the drag chain and the drag chain groove.

Specifically, when the trolley runs in the first half of the guide rail, there is no need for the drag chain 7 to turn or perform other operations. Therefore, only the supporting roller 1 is needed to fix and support the drag chain 7. The spacing between the rollers is not fixed and mainly depends on the material of the drag chain 7. Although there is only one roller during the first half of the distance, due to the presence of the supporting roller 1, there is no need for the drag chain groove 4 to place a motor drive line required for driving a trolley or a drive line matched with a guide rail. At the second half when the trolley runs, a respective auxiliary roller 2 spacing from the supporting roller 1 is provided according to the material of drag chain 7 and the turning radius of drag chain 7, so that the drag chain 7 can be capable of turning. During the movement of the trolley, due to the auxiliary roller 2, the drag chain 7 can be conducted through the auxiliary roller 2, and the auxiliary roller 2 also saves the step of further extending the groove to place the lines.

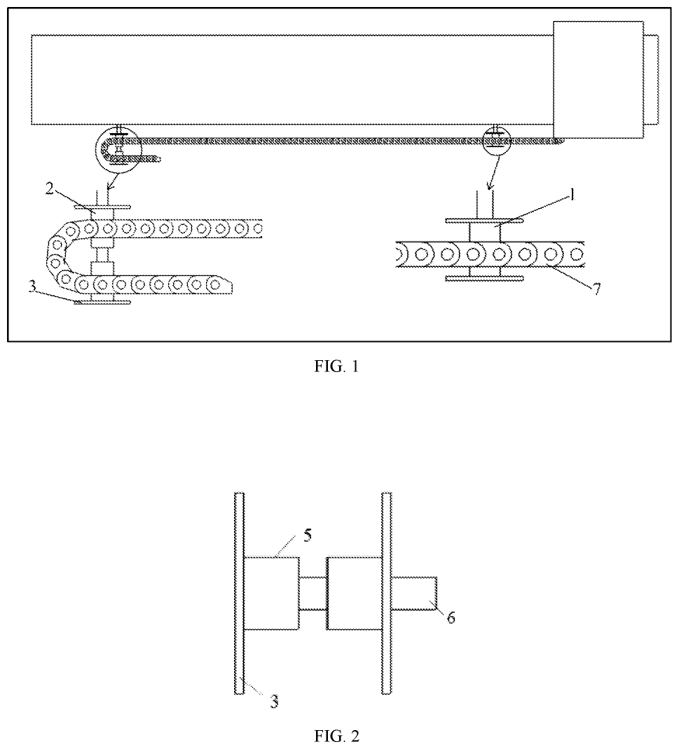

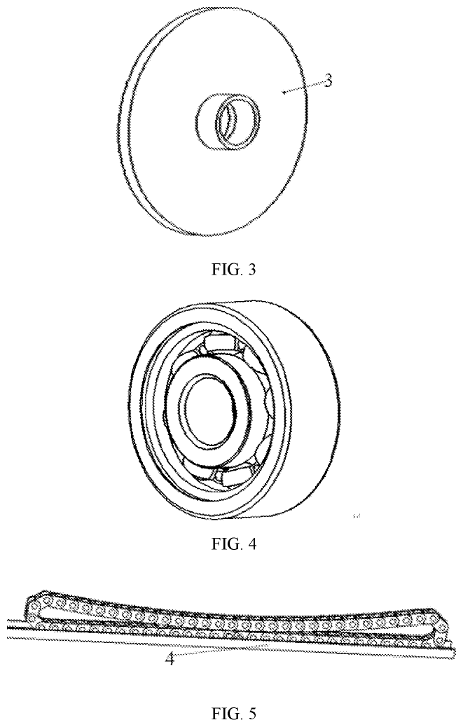

As shown in FIGS. 2 to 4, in a specific embodiment, the auxiliary roller 2 includes two roller covers 3, a bearing 5 disposed between the two roller covers 3 and a support shaft 6 disposed on a side of one of the two roller covers 3 facing away from the bearing 5. An end of the support shaft 6 is connected to the side of one of the two roller covers 3 facing away from the bearing 5, and another end of the support shaft 6 is configured to be connected to the guide rail. A turning radius of the drag chain 7 at the auxiliary roller 2 is less than a distance between the two roller covers 3. In the embodiment, the bearing 5 is a rolling bearing. Due to the high machining accuracy of each component, the rolling friction generated inside the roller during the movement of the guide rail will be relatively small.

### Embodiment 2

The structure of the drag chain mechanism in the disclosure has been applied to an 80 m aerostatic guide rail in a large length chamber of the National Institute of Metrology, China. Due to the absence of friction between the guide rail platform and the guide rail after ventilation, the main sources of friction for the guide rail are generated by the driving wheels of the motor and the drag chain. Before conducting the experiment, the motor driving wheels of the guide rail should be fixed to exclude the friction brought by the contact between the motor driving wheels and the guide rail. Therefore, the external resistance source is only the friction brought by the drag chain.

The followings are tension data suitable for the two placement methods of the drag chains on the rails.

Based on the 80 m aerostatic guide rail, an external tension is applied to the guide rail platform by using a tension meter, and a first force applied when the guide rail reaches a uniform motion level and a second force applied after reaching the uniform motion level are monitored separately. The results are as shown in Table 1.

TABLE 1
Tension indication of different placement methods

| Placement | | uniform |
|---|---|---|
| method of drag | Start stage/ | motion stage/ |
| chain | (newton) N | N |
| Vertical | 1 | 10.5 |
| Horizontal | 8 | 45 |

The drag chain is disposed horizontally (as shown in FIG. 5), and the drag chain is disposed in the drag chain groove 4. A length of the drag chain is a length of the guide rail, and a travel distance is also the length of the guide rail. Due to the weight of the guide rail, there is a maximum stacking area of the drag chain, and there are relative motion and friction issues between the stacked two layers of the drag chain. Due to the non-smooth surface of the drag chain, there is a significant frictional force. In addition, the problem of a friction between the drag chain and the guide rail groove can lead an increase in friction force as the stacking area increases.

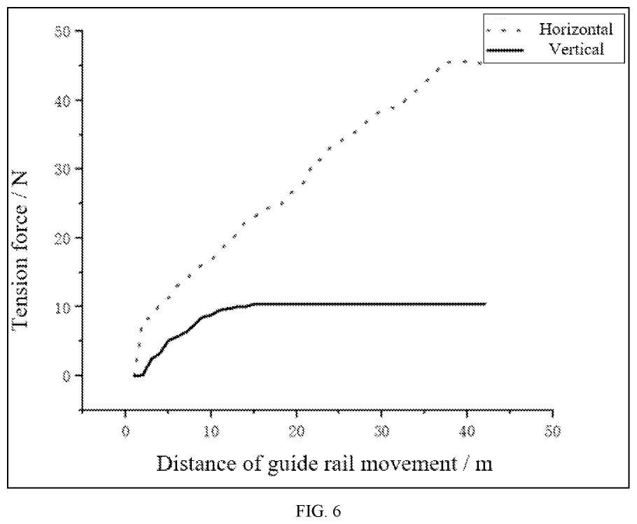

As shown in FIG. 6, a starting point of the horizontal axis in FIG. 6 is corresponding to a position when the drag chain outside of the guide rail is fixed as shown in FIG. 1 (the length of the drag chain is usually ½ of the length of the guide rail). Due to the phenomenon of drag chain stacking at the position of the starting point during the horizontal installation, compared to the vertical installation, the tension applied in the initial movement stage of the platform is already close to the tension applied in the uniform speed period of vertical installation. As the running distance on the guide rail increases, the stacking area of the drag chain will further increase, and the frictional force will gradually increase. The gradually increased frictional force is very unfavorable for the motor to control the accuracy of the guide rail movement. When the guide rail runs to a position of 50 m, the stacking area of the drag chain reaches its maximum, and the external tension tends to reach its maximum value of 45 N. However, in the vertical installation of the drag chain, when the guide rail runs to a position of 15 m, the frictional force caused by the drag chain has already stabilized at 10 N, which greatly improves the precision control of the motor on the guide rail movement. Therefore, the experimental results confirm that the disclosure also greatly improves the frictional force brought by the drag chain during the movement of long guide rails.

The vertically-mounted micro friction drag chain mechanism in the disclosure is mainly used for accuracy detection of guide rails larger than 30 m. The size of the drag chain can be determined based on the actual guide rail, and the installation distance of the auxiliary roller is also determined based on the actual spatial position. Generally, the distance between the two roller covers only needs to be slightly larger than the minimum turning radius of the drag chain.

Before conducting measurements, it is necessary to check the placement of the drag chain and place the drag chain vertically in the middle of the rollers, and check whether the minimum turning radius of the drag chain at the turning point meets the standard. Due to the different placement methods of the drag chain, its effect on the guide rail will not affect the friction force with increasing running distance, thereby affecting the detection accuracy.

For those skilled in the art, it is evident that the disclosure is not limited to the details of the exemplary embodiments mentioned above, and can be implemented in other specific forms without departing from the spirit or basic features of the disclosure. Therefore, from any perspective, the embodiments should be regarded as exemplary and non-restrictive, and the scope of the disclosure is limited by the attached claims rather than the above descriptions. Therefore, it is intended to encompass all variations that fall within the meaning and scope of equivalent elements of the claims within the disclosure.

In addition, it should be understood that although the specification is described according to the implementation methods, not each implementation method only includes an independent technical solution. This description in the specification is for clarity only. Those skilled in the art should treat the specification as a whole, and the technical solutions in each implementation method can be appropriately combined to form other implementation methods that those skilled in the art can understand.

What is claimed is:

1. A vertically-mounted micro friction drag chain mechanism, comprising:
a supporting roller (1), and an auxiliary roller (2);
a vertically-mounted drag chain (7); wherein an end of the drag chain (7) is disposed on the supporting roller (1); another end of the drag chain (7) extends from the supporting roller (1) to the auxiliary roller (2), turns at the auxiliary roller (2) and extends towards the supporting roller (1); and the supporting roller (1) is configured to drive the drag chain (7) on the auxiliary roller (2) to move.

2. The vertically-mounted micro friction drag chain mechanism as claimed in claim 1, wherein the supporting roller (1) is configured to support the vertically-mounted drag chain (7) and place a motor drive line required for driving a trolley or a drive line matched with a guide rail in the vertically-mounted drag chain (7).

3. The vertically-mounted micro friction drag chain mechanism as claimed in claim 1, wherein the auxiliary roller (2) comprises:
two roller covers (3);
a bearing (5), disposed between the two roller covers (3);
a support shaft (6), disposed on a side of one of the two roller covers (3) facing away from the bearing (5), wherein an end of the support shaft (6) is connected to the side of the one of the two roller covers (3) facing away from the bearing (5), and another end of the support shaft (6) is configured to be connected to a guide rail.

4. The vertically-mounted micro friction drag chain mechanism as claimed in claim 2, wherein a turning radius of the drag chain (7) at the auxiliary roller (2) is less than a distance between the two roller covers (3).
